(19) United States
(12) Patent Application Publication
(10) Pub. No.: US 2026/0043227 A1
(43) Pub. Date: Feb. 12, 2026

(54) ROTATING DEVICE AND ROTATING PLATE ARRANGEMENT

(71) Applicant: MACK RIDES IP GMBH & CO. KG, Waldkirch (DE)

(72) Inventor: Günter BURGER, Waldkirch (DE)

(21) Appl. No.: 18/998,783

(22) PCT Filed: Apr. 20, 2023
(86) PCT No.: PCT/EP2023/060359

§ 371 Date: Jan. 27, 2025

(30) Foreign Application Priority Data
Aug. 8, 2022 (DE) 102022119937.1

(51) Int. Cl. E04B 1/346; B60S 13/02

(52) U.S. Cl. CPC E04B 1/346; B60S 13/02

(57) ABSTRACT

The present invention relates to a rotating device for integration in a substrate, preferably in a building floor element, more particularly in a screed floor, having at least three support units, which can be arranged individually in the circumference of the substrate within a circular area about an axis of rotation, a rotating plate which extends at least over the circular area and has a room side and a bearing side opposite the room side, a rotary bearing unit, and at least one drive apparatus, wherein the rotating plate is rotatably mounted in the axis of rotation and the at least three support units support the rotating plate in a rotationally movable manner in the orientation of the axis of rotation in a vertical axis on the bearing side, and wherein the drive apparatus is configured to set the rotating plate in rotation about the axis of rotation.

The present invention relates to a rotating device for integration in a substrate, preferably in a building floor element, more particularly in a screed floor, with the features of claim 1 and a rotating plate arrangement with such a rotating device with the features of claim 24.

Rotating devices in various configurations are known from the state of the art. Rotating devices are known, for example, as rotating plates, rotary tables and for various other applications. By way of example, rotating plates can be found as popular attractions in playgrounds as running discs or as carousels.

Rotating devices with a larger diameter and a higher static load often exhibit a large construction and are frequently complex, heavy, and associated with considerable costs.

For example, WO 98 30424 A shows a rotating plate device for absorbing high static loads. A base plate and a rotating plate that counter-rotates relative to the base plate are provided, wherein the rotating plate is mounted on the base plate by means of support bearings arranged on the outer circumference and the base plate is supported on the substrate. The rotating plate is arranged at a distance from the substrate, as a result of which the rotating device exhibits a relatively tall overall height and a step at the edge of the rotating plate must be overcome in order to access the rotating plate. In particular when integrating such rotating plate devices into buildings, such steps pose points of danger.

This is where the present invention comes into play.

Based on this state of the art, it is the task of the present invention to propose an expediently improved rotating plate device which eliminates the disadvantages known from the state of the art. The rotating plate device to be proposed should be able to be retrofitted in existing buildings, where it can be integrated as flush as possible into a building floor element, whereby changeable spaces can be achieved.

These tasks are solved by a rotating plate device for integration in a substrate, preferably in a building floor element, more particularly in a screed floor, with the features of patent claim 1 and a rotating plate arrangement with the features of patent claim 24.

Additional advantageous further developments of the invention are given in the subclaims.

The rotating plate device according to the invention for integration in a substrate, preferably in a building floor element, more particularly in a screed floor, with the features of claim 1, has at least three support units which are arranged circumferentially within a circular area about an axis of rotation and can respectively be inserted individually into the substrate in a recess. The rotating device, moreover, has a rotating plate which extends at least over the circular area and has a room side and a bearing side opposite the room side. A rotary bearing unit and at least one drive apparatus are moreover provided, wherein the rotating plate is rotatably mounted in the axis of rotation by the rotary bearing unit and the at least three support units, isolated from the rotary bearing unit, support the rotating plate in a rotationally movable manner in the orientation of the axis of rotation in a vertical axis on the bearing side and wherein the drive apparatus is configured to set the rotating plate in rotation about the axis of rotation.

The at least three support units and the rotary bearing unit according to the present invention are not directly connected to one another. The at least three support units and the rotary bearing unit can be embedded separately and independently of one another in recesses in the substrate, in particular a floating standard screed floor, and can be arranged there in a recess. The at least three support units and the rotary bearing unit are thus indirectly connected to each other by the substrate, whereby, for example, an existing building floor, more particularly in a screed floor, can be used as a load-bearing structure and a system that is highly flexible in terms of size and load-bearing capacity is created with simple means, which can also be easily retrofitted in existing buildings due to the low installation height. The proposed rotating device is therefore resource-saving, flexible, efficient and suitable for a wide range of applications. The fact that the at least three support units and the rotary bearing unit are integrated into the substrate, in particular into the floor element, and even more preferably into the screed floor, means that all load-related and natural settlement phenomena can be flexibly compensated for. The physical properties of a building in terms of thermal and acoustic insulation are also only very slightly changed, which is why the proposed rotating device is suitable for living, sleeping and working spaces.

The rotating device is therefore suitable for retrofitting as well as for planned new construction and corresponding combinations thereof. One of the advantages to be emphasized compared to the known state of the art is that only small and punctual interventions in the substrate, in particular the screed, are required, as a result of which the substrate, in particular the screed, loses only insignificantly or not at all in load-bearing capacity and may break. The substrate in the area of the rotating device may, moreover, be reinforced with a preferably flat-coated fabric if required. The fabric can also reinforce the substrate over the circular area, preferably over a large area.

The rotating device adapts to completely different settlement and expansion behavior. This makes it possible to control the height level of the substrate, in particular the finished floors, in relation to the room side of the rotating plate, which means that the proposed solution meets the qualitative and visual architectural requirements of today.

Another advantage is that the availability of a proposed, individual and easy-to-use rotating device also opens up new, very compact and attractive living and workspace concepts. More individual possibilities can be created with less space. The rotating device can also function as a replacement for very large doors with increased usage options. Furthermore, the rotating device can also be used in storage spaces and/or access points such as doors, wherein the applications listed are not limited to the examples mentioned above.

A further development of the present invention provides that the at least one drive apparatus is arranged on and/or under the rotating plate. Consequently, the at least one drive apparatus rotates together with the rotating plate about the axis of rotation during a rotation of the rotating plate.

According to a preferred further development of the present invention, the at least one drive apparatus is arranged substantially on the room side of the rotating plate. This means that it is accepted that the drive apparatus is arranged on the room side of the rotating plate (at least predominantly), the room side of the rotating plate can thereby be arranged approximately flush with the substrate.

In an alternative configuration, the at least one drive apparatus can be arranged substantially on the bearing side, whereby the room side of the rotating device can be barrier-free. A rotating device of such a type can, for example, serve as a dance, show or presentation area.

It is also possible that the drive apparatus is firmly connected to the substrate and drives the rotating plate. Combinations of the drives described above are also possible. A combination of at least one drive apparatus on the rotating plate and at least one drive apparatus on the substrate can be advantageous, particularly in the case of very large rotating plates. The drive apparatus, which is fixed to the substrate under the platform, does not rotate against the at least one drive unit on the rotating plate. The two drive apparatuses do however complement each other through appropriate synchronization. For the at least one drive apparatus acting underneath the platform, a friction surface or alternatively friction lining is then to be provided in addition to the skeletal structure or the like on the bearing side of the rotating plate. This drive apparatus can also interact with the bearing surface on the skeletal structure.

Such a combination or an exclusive arrangement of the drive apparatuses on the substrate may then be particularly advantageous if the drive apparatuses interfere on the upper side and, for example, a wooden beam slab or also a solid or concrete slab is combined with a floating screed. In this case, drive apparatuses could be provided on the bearing side of the rotating plate or on the substrate, which is no problem in most cases.

Preferably, the at least one drive apparatus can be arranged concealed in a piece of furnishing such as a chest of drawers, a cupboard, a couch, a bed or the like, whereby the appearance of the room is not disturbed by the drive apparatus protruding on the room side. Alternatively, the at least one drive apparatus can also be concealed in a room-dividing element, such as a wall, a wall plate or the like.

A preferred further development of the present invention provides that the at least one drive apparatus comprises a friction wheel. The friction wheel is driven by the drive apparatus and, according to a preferred configuration, can roll on a friction surface, in particular the substrate. The friction wheel can, moreover, be configured as a tire and/or, in one conceivable configuration, has a running surface made of plastic or rubber. In so doing, running noises of the friction wheel can be reduced and furthermore a sufficient adhesion of the friction wheel on the substrate can be ensured even if the substrate is slightly uneven.

According to a further configuration of the present invention, the friction wheel passes through the rotating plate through a friction wheel recess. Preferably, the friction surface and the friction wheel or its bearing and/or drive are arranged on opposite sides of the rotating plate. The friction wheel can thus have a very large diameter compared to the plate thickness of the rotating plate, whereby on the one hand a simple construction of the rotating device can be achieved and on the other hand the friction wheel of the at least one drive apparatus can apply a sufficiently large force to set the rotating plate in rotation about the axis of rotation.

According to a preferred configuration of the present invention, the drive apparatus can be detachably mounted as a unit on the room side of the rotating plate. The drive apparatus can, moreover, comprise a rack, wherein the rack comprises a decoupling device, which, in terms of vibration mechanics, preferably decouples the friction wheel and/or the drive from the rotating plate. This suppresses the transmission of running noises from the friction wheel to the rotating plate and a corresponding configuration of the decoupling device can ensure that the friction wheel is pressed against the friction surface with a predefined contact pressure.

It has, moreover, proven to be advantageous if a slip ring unit and a brush unit interacting with the slip ring unit are provided. The slip ring unit and the brush unit enable the rotating plate to be supplied with electrical current. Preferably, the slip ring unit and the brush unit transmit mains current, for example ˜230 V at 50 Hz, which means that conventional electrical devices on the rotating plate, such as lights, media devices, or similar, can be operated there. In addition, the power supply can provide the drive apparatus with the necessary energy.

Preferably, the rotary bearing unit comprises the slip ring unit. The brush unit can be detachably attached to the rotating plate, allowing the brush unit to be replaced without significant effort.

Preferably, the rotary bearing unit moreover comprises a base part and a rotating plate part. The rotating plate part is rotatably supported on the base part by means of a bearing, wherein the rotating plate part is also preferably rotatably displaceable along the axis of rotation relative to the base part. The special feature of the rotary bearing unit is that the base part has an important special feature when it is fixed to the raw slab. In this case, the axis of rotation Z is firmly fixed to the substrate or the building and the structure of the rotating plate can compensate for the special feature of a floating screed, which naturally rests on insulation and a vapor barrier. In concrete terms, this means that if the screed settles and deforms slightly over the years due to its own weight and corresponding uneven loads caused by use, these changes can be automatically compensated for. In so doing, this can result in the axis of rotation of the rotating device needing to be able to compensate for the axis of rotation Z of the firmly fixed component without tension due to the changes in geometry resulting from settling and warping. In so doing, it can also result in slight wobbling. Also and in particular inasmuch as, according to a preferred embodiment, the rotating plate is configured in such a way that, as a flexible membrane with the load distribution over the support units, it can completely compensate for these geometric changes via connecting pieces, which in this case can be made of a special pressure-resistant sliding material made of plastic.

In special cases, in particular when several rotating devices are mounted on a substrate, in particular on a screed, it can also be advantageous from a structural-physical point of view if the rotary bearing unit is also bonded into the floating part of the substrate, in particular the screed. This is advantageous in order to avoid stresses between the axis of rotation and a construction joint between the respective rotating plates at the transition to the floor covering fixed to the substrate. In this case, there is no positive-locking and/or non-positive-locking connection to the fixed structure, but rather only to the floating part of the substrate itself.

One of the advantages of the rotating device can be seen in the joints between the substrate and the rotating plate. This joint can be kept relatively small and is very forgiving with regard to possible offsets in height and coefficients of expansion, inasmuch as the rotating plate represents a relatively soft membrane that, depending on the intended load brought about by use, rests on different numbers of support units. In this way, the area offers many advantages, both technically for barrier-free transitions as well as visually from qualitative and furnishing-specific aspects.

A further development of the present invention provides that a control unit is provided. The control unit is configured, in particular, to implement corresponding control commands with the drive apparatus or alternatively to control it. The control unit can, moreover, preferably be remote-controlled, wherein the control unit can receive control commands either by radio or by cable by means of the slip ring unit and the brush unit interacting with the slip ring unit. The control commands can either be transmitted to the control unit by means of at least one separate conductor or modulated onto the current-carrying conductor(s), for example in the form of an AS-i bus system.

According to a preferred further development of the present invention, the drive apparatus comprises an electric drive for generating the rotation of the rotating plate about the axis of rotation. The drive apparatus can drive the rotating plate by a variety of known drive forms. By way of example, gear teeth, chain and belt drives, linear motors (LIM/LSM) are mentioned here, wherein this list is not exhaustive.

It should be noted at this point that it is also conceivable to drive the drive apparatus hydraulically or pneumatically.

In addition, a further development of the present invention provides that at least one of the at least three support units comprises a roller bearing element supported on the housing. The roller bearing element comprises a rolling element arranged movably on the housing, which preferably projects from the housing and by means of which the rotating plate is supported on the housing. During one rotation of the rotating plate, the rolling element rolls on the rotating plate.

The rolling element can, for example, comprise a roller or a ball, wherein the rolling element can also have a rolling element surface made of metal, rubber or plastic, by means of which the rolling element can roll particularly silently on the rotating plate.

To further optimize the rolling behavior of the rolling element, the rotation axis of the respective rolling element can be tilted, in such a way that the respective outer diameter of the inside and outside of the roller corresponds to the axis of rotation at exactly the same speed of the inner and outer rotational path of the respective rolling element. This allows greater loads to be transferred to the rolling element and improves the rolling behavior to the extent that unpleasant squeaking and/or rubbing noises are avoided. It can, moreover, be advantageous if the rollers, in particular the rollers that are close to the axis of rotation, are crowned in order to avoid any running noises.

A further development of the present invention, moreover, provides that at least one of the at least three support units comprises an air bearing means or gas bearing means. The air bearing means or gas bearing means preferably comprises a housing and is further preferably configured to keep the rotating plate separated from the at least one of the at least three support units by a thin film of gas or air. By means of the stick-slip-free and friction-free movement between the at least one of the at least three support units and the bearing side of the rotating plate, the rotating plate can be moved particularly smoothly. For example, such a rotating plate can be moved by hand and/or the power of the drive apparatus can be reduced. Noise during rotation of the rotating plate can also be reduced in this way.

It has also proven to be advantageous if a supporting surface is provided on the housing. In a preferred configuration, the housing can be configured like a sleeve and the supporting surface can protrude from the housing like a flange. The housing is supported on the substrate by means of the supporting surface. In addition, the housing can have one or more transverse and/or longitudinal grooves on its outer surface, whereby the support unit can be inserted like a dowel into the respective recess in the substrate.

It has, moreover, proven to be advantageous if the support unit has fastening means by means of which the support unit can be fastened to the substrate. For example, one or more clamping screws or clamping claws can be provided.

According to a preferred further development of the present invention, adjusting means are provided by means of which the roller bearing element can be adjusted in the vertical axis of the support unit. It is preferred, in particular, if the roller bearing element can be adjusted by the adjusting means in the vertical axis relative to the housing of the support unit. The adjusting means make it possible to compensate for any unevenness of the substrate in order to ensure very smooth running and uniform support of the rotating plate over the circumference.

The adjusting means can also comprise a sleeve that is movable in the vertical axis relative to the housing and can be fixed in position relative to the housing by corresponding fixing means. For example, the sleeve can be a screw sleeve that can be screwed into the housing, wherein the fixing means can prevent the sleeve from rotating relative to the housing.

It has, moreover, proven to be advantageous if the rotating plate has at least one preferably annular bearing surface on the bearing side. The at least one, preferably annular, bearing surface can be arranged concentrically to the axis of rotation.

Preferably, the rotating plate has a plurality of bearing surfaces arranged coaxially to one another on the bearing side around the axis of rotation, whereby a plurality of support units can be arranged both in the circumferential direction and at different radii in relation to the axis of rotation. The weight of the rotating plate and the objects arranged on the rotating plate can be evenly distributed on the substrate by means of the plurality of support units.

According to a preferred further development of the present invention, the rotating plate, that is preferably adjacent to the at least one annular bearing surface, has at least one aperture through which at least one of the at least three support units is accessible. The adjusting means of the support units can, in particular, be actuated through the aperture, whereby the respective support units can be individually adjusted for the best possible support of the rotating plate.

It has, moreover, proven to be advantageous if the rotating plate is circular and has a diameter that is preferably >4 m.

It has, moreover, proven to be advantageous if the rotating plate is made up of a plurality of, preferably circular sector-shaped, elements. This measure avoids particularly large and complex components and the individual components of the rotating plate device can also be transported through narrower doors and corridors of existing buildings. This makes it easy to retrofit rooms with the rotating plate device, even in existing buildings with such a rotating device.

It has, moreover, proven to be advantageous if the at least three support units have a length in the vertical axis that is less than 50 mm and even more preferably less than 45 mm. These dimensions of the length of the respective support unit ensure that the support units can be incorporated into standard screed systems with a layer thickness of between 4.5 cm and 6 cm without needing to break through any separating or heat insulation layers, which would have a negative effect on the thermal and acoustic insulation.

A further development of the present invention provides that a room-dividing element, in particular a room partition, a wall, a drywall, a wall plate or the like, is arranged on the room side of the rotating plate. According to a preferred configuration, the room partition can separate a room into two sections. The respective section can be moved in the room by means of a rotation of the rotating plate, whereby different scenarios can be set up in the room. For example, one section can represent a sleeping area and another section a living area, wherein the living area or the sleeping area can be rotated or alternatively moved into the room as desired. It is thereby possible, for example, to position both the bedroom and the living room in front of a window or a balcony, whereby the use of the room can be used more flexibly and the spatial position of a room can be used more intensively. If, for example, the spatial position offers a particularly spectacular view, the same view can be enjoyed from the living area during the day and from the sleeping area at night. The rotating device can, moreover, also provide additional entertainment by creating gentle, dynamic and/or continuous rotations or movement patterns using the drive apparatus. On the basis of the particular use of the rotating device in a building floor element of a room, the rotating device can also be referred to as a building floor rotating device.

A preferred further development of the present invention provides that at least one electrical outlet is arranged on the room side of the rotating plate. The electrical outlet provides a voltage source for fixtures on the rotating plate and is further preferably supplied with electric current, in particular mains voltage, by means of the slip ring unit and the brush unit.

A further aspect of the present invention relates to a rotating plate arrangement with a rotating device described above and a substrate, preferably a building floor element, in particular a screed floor, wherein the at least three section units and the rotary bearing unit are embedded and supported in recesses in the substrate.

According to a preferred configuration of the present invention, the substrate is a floating screed.

A further development of the rotating plate arrangement can comprise at least one driverless vehicle that can drive over the substrate and the room side of the rotating plate of the at least one rotating device. The at least one driverless vehicle can drive on to and off of the at least one rotating device. A control system can control both the at least one driverless vehicle and the at least one rotating device in a synchronized manner. The networked control of the at least one rotating plate and the at least one driverless vehicle can create a type of eco-system that has considerable utilization potential.

The proposed rotating device or alternatively the proposed rotating plate arrangement also opens up completely new possibilities for optimizing the living space for people with disabilities. In such a case, the control of everyday configurations via voice control can be of great benefit. Voice commands that trigger the number of degrees, speeds, and stop commands could also make operation much more user-friendly. It is conceivable, for example, to provide the rotating plate with a remote control and/or operating elements. In this way, for example, in combination with at least one control element, the corresponding safety criteria can also be complied with.

In the following, with reference to the accompanying drawing, an embodiment of the present invention is described in detail. Wherein:

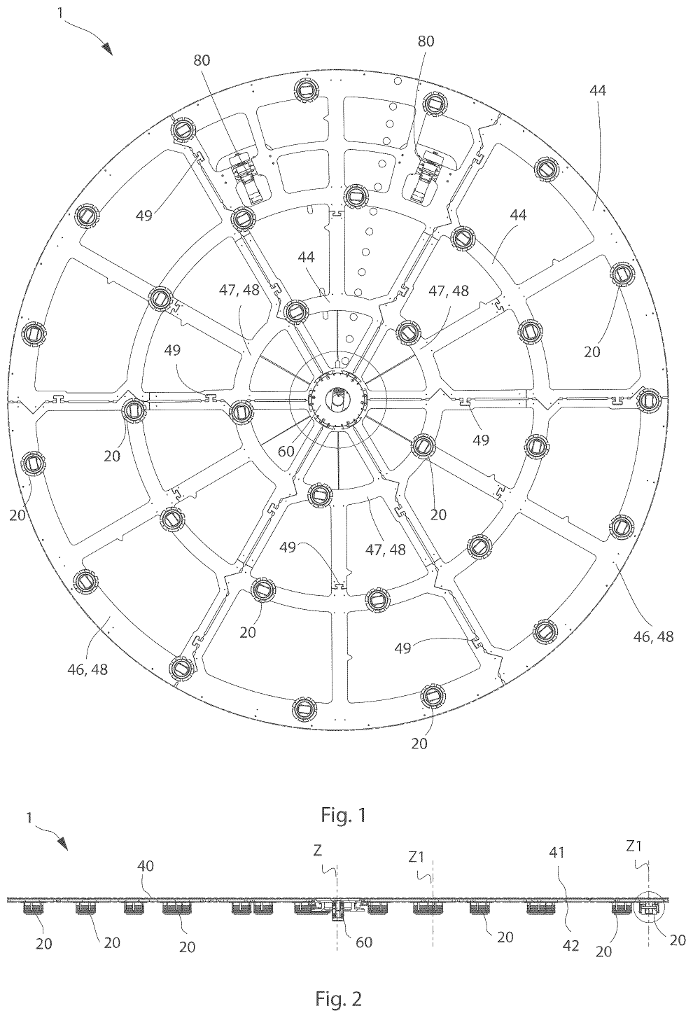

FIG. 1 shows the rotating device in a view from below with several support units, a rotating plate, a rotary bearing unit and two drive apparatuses with a detailed reference for a slip ring unit, which is provided for the supply of electrical energy to the rotating plate,

FIG. 2 shows a cross-sectional view of the rotating device according to FIG. 1,

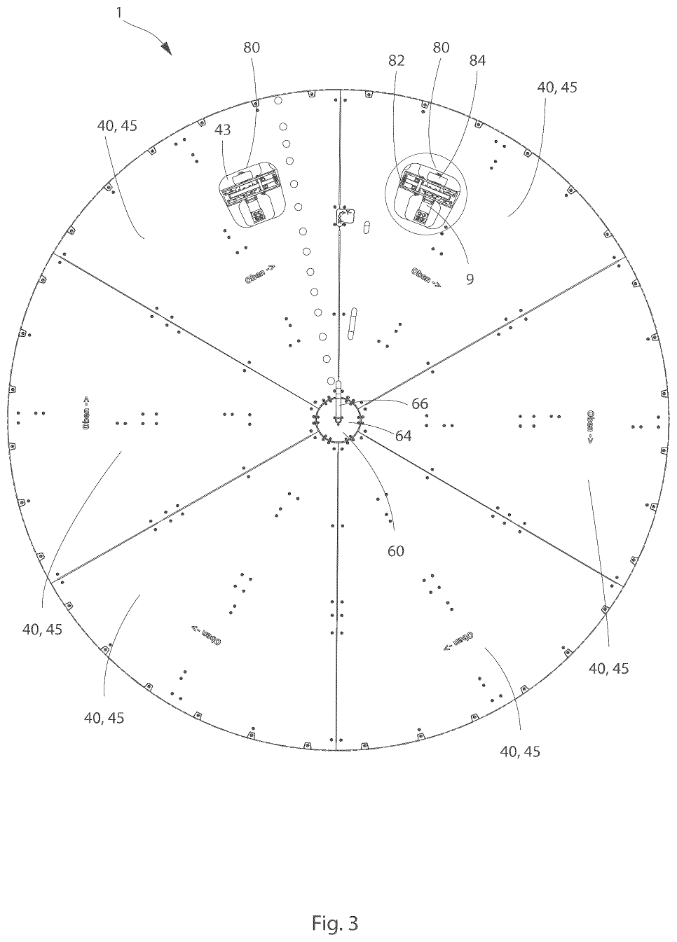

FIG. 3 shows a top view of the rotating device shown in FIG. 1,

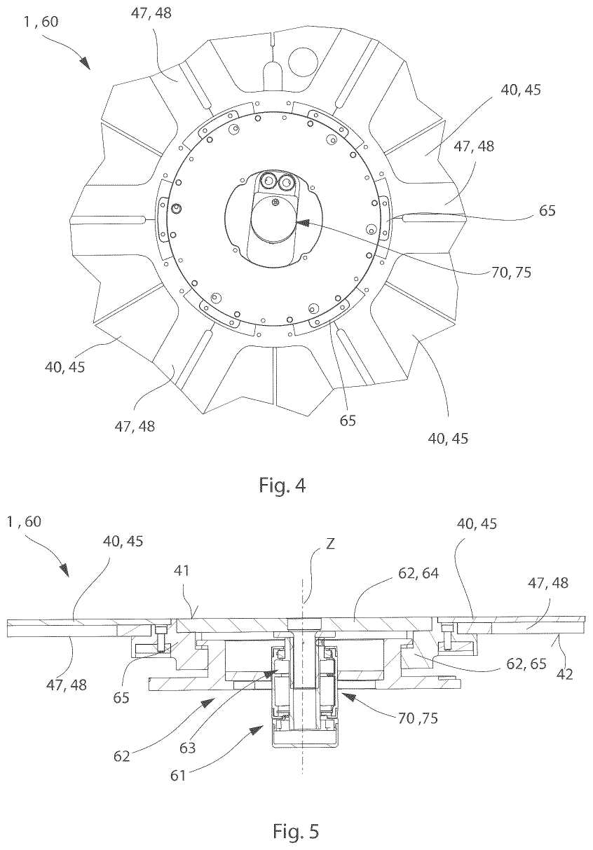

FIG. 4 shows a detailed view according to the detailed reference from FIG. 1,

FIG. 5 shows a cross-sectional representation of the slip ring unit as shown in FIG. 1 and FIG. 4,

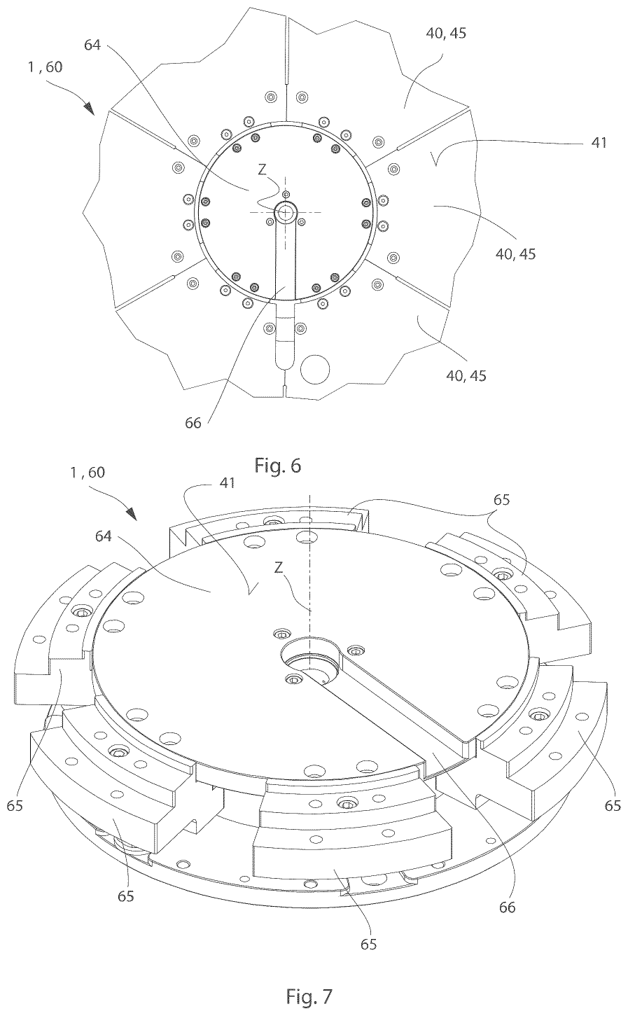

FIG. 6 shows a detailed view of the slip ring unit from above as shown in FIG. 3,

FIG. 7 shows an isometric view of the slip ring unit,

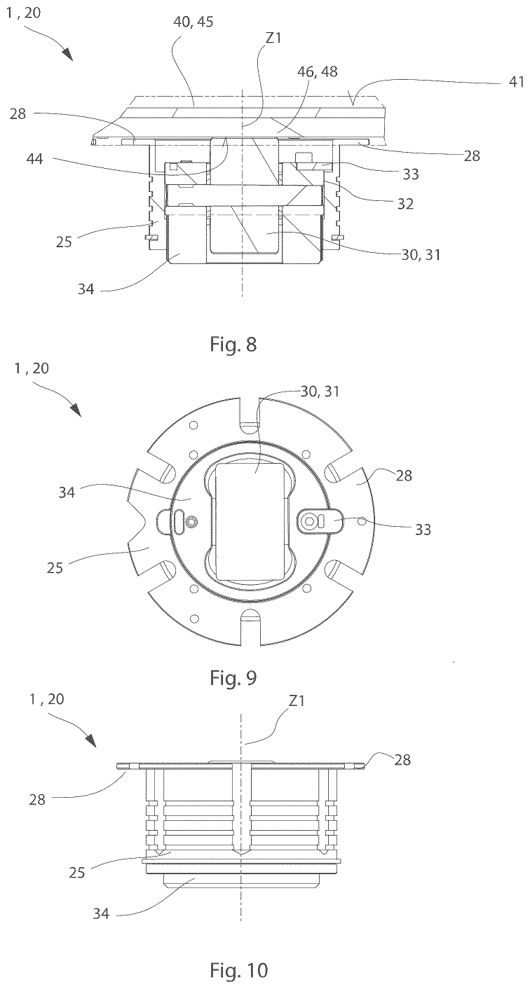

FIG. 8 shows a simplified cross-sectional representation of a support unit,

FIG. 9 shows a simplified view from above of the support unit as shown in FIG. 8,

FIG. 10 shows a side view of the support unit,

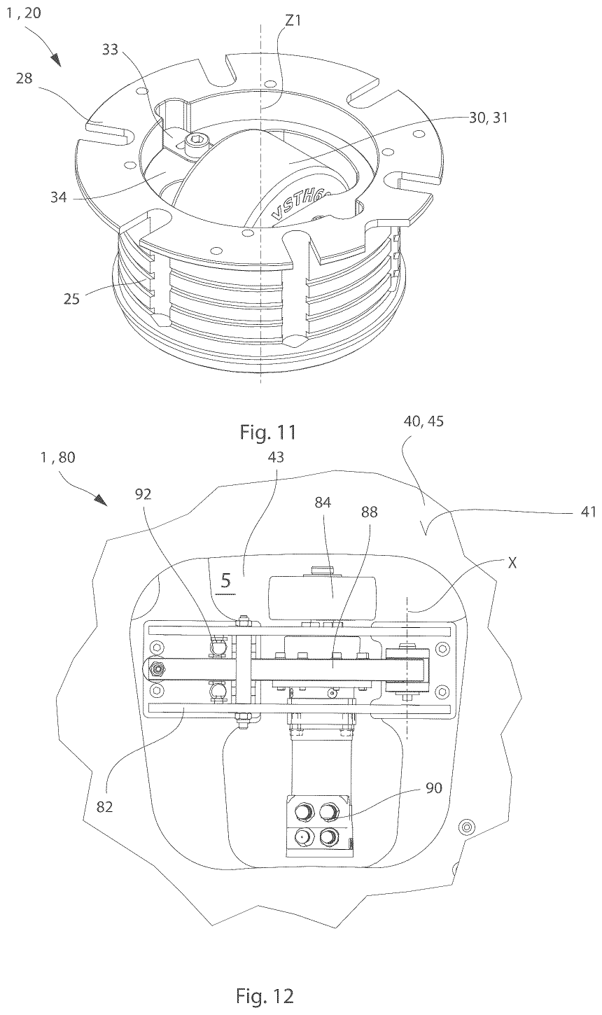

FIG. 11 shows an isometric view of the support unit as shown in FIG. 7 through FIG. 10,

FIG. 12 shows an enlarged detailed view of the drive apparatus,

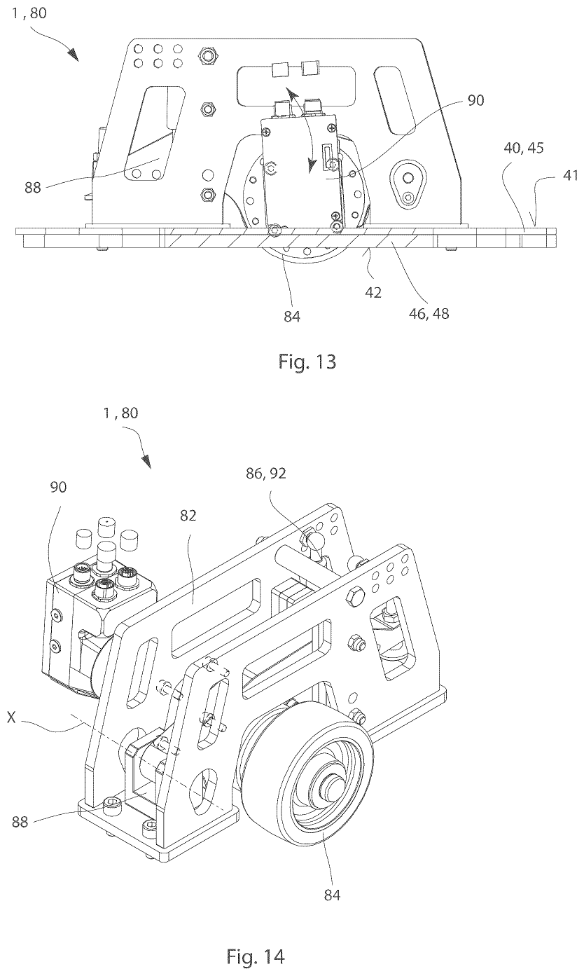

FIG. 13 shows a side view of the drive apparatus,

FIG. 14 shows an isometric view of the drive apparatus as shown in FIG. 12 and FIG. 13,

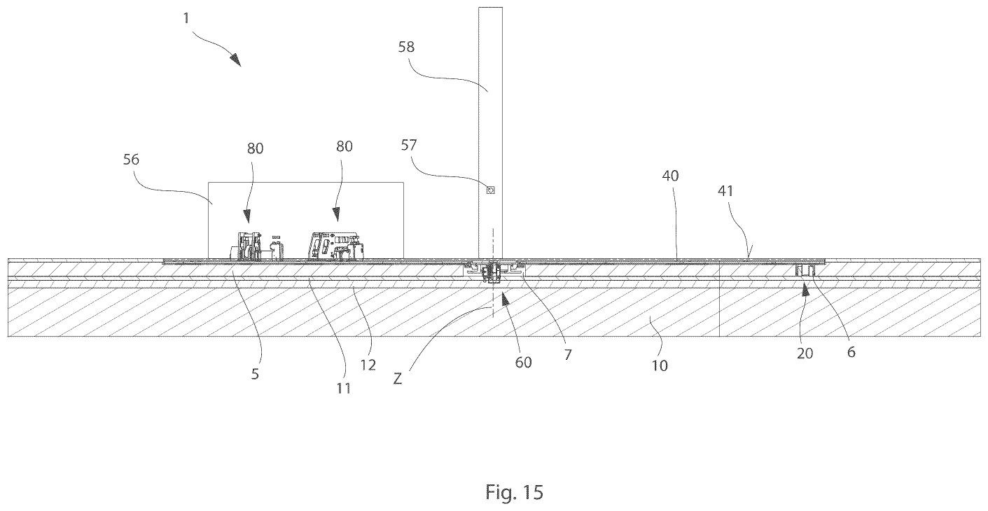

FIG. 15 shows a rotating plate arrangement with the rotating device and a substrate, preferably a building floor element, more particularly in a screed floor, wherein the at least three support units and the rotary bearing unit are embedded and supported in recesses in the substrate, and

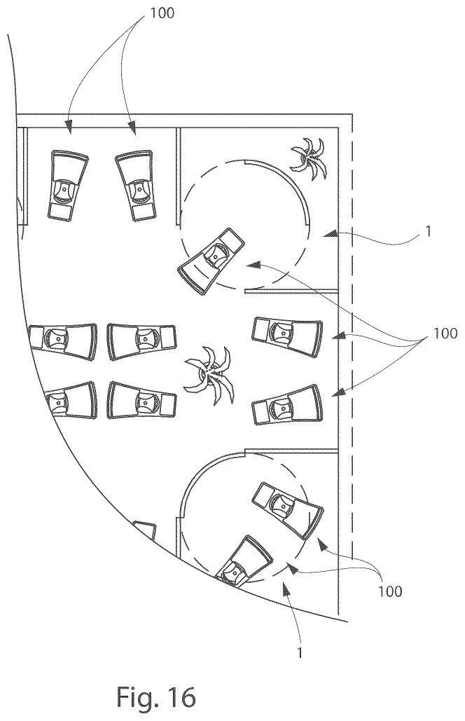

FIG. 16 shows a further development of the rotating plate arrangement with several driverless vehicles.

Identical or functionally identical parts or features of a preferred embodiment of the invention are identified with the same reference numbers in the following detailed description of the figures. Moreover, not all identical or functionally identical parts or features are provided with a reference numeral in the figures.

FIG. 1 shows a rotating device 1 for integration into a substrate 5 (see FIG. 15), which in the preferred embodiment described here is a floating screed floor. The rotating device 1 for integration into a substrate has a plurality of support units 20, a rotating plate 40, a rotary bearing unit 60, and at least one drive apparatus 80, wherein the drive apparatus 80 in FIG. 1 is partially concealed by the rotating plate 40.

The rotating plate 40 can have the shape of a circular rotating disk which extends at least over the circular area. The rotating plate 40 is rotatably mounted in an axis of rotation Z by the rotary bearing unit 60, wherein the axis of rotation Z corresponds to the rotation axis of the rotating plate 40.

As shown in FIG. 2, the rotating plate 40, moreover, has a room side 41 and a bearing side 42 opposite to the room side 41 along the axis of rotation Z. When the rotating device 1 is used as intended, the bearing side 42 faces the substrate 5 and the room side 41 faces away from the substrate.

As can be taken from FIG. 1 and FIG. 3, the rotating plate 40 can be composed of a plurality of elements 45, wherein the elements 45 can be circular sector-shaped. The size of the circular sectors of the respective elements 45 is preferably the same.

The rotating plate 40 or alternatively the elements 45 can be made of an elastic material, whereby the rotating plate 40 can be configured in the manner of a flexible membrane or alternatively flexible plate. Through deformation, the rotating plate 40 can follow the unevenness of the substrate and follow the settlement behavior of the substrate 5.

The rotating plate 40 can, moreover, comprise a skeletal structure 46 that is arranged on the bearing side 42 of the rotating plate 40. The skeletal structure 46 can be formed from a plurality of inner and outer frames 47, 48.

In the illustrated embodiment example, an inner frame 47 and an outer frame 48 each form a skeletal structure section corresponding to the circular sector of the elements 45.

The frames 47, 48 and/or the skeletal structure sections can be connected to each other by corresponding positive-locking elements 49, which can form a puzzle-like positive-lock between adjacent frames 47, 48 and/or the respective adjacent skeletal structure sections.

One skeletal structure section respectively connects two elements 45, wherein the skeletal structure section preferably is arranged centrally between two elements 45 in the circumferential direction about the axis of rotation Z.

The elements 45 can be screwed onto the skeletal structure 46.

FIG. 4 through FIG. 7 show enlarged representations of the rotary bearing unit 60. The rotary bearing unit 60 comprises a slip ring unit 70 and a brush unit 75 cooperating with the slip ring unit 70.

The slip ring unit 70 and the brush unit 75 are configured to supply the rotating plate 40 with an electrical current. For this purpose, the slip ring unit 70 can, in particular be connected to a power source, preferably the power grid, and preferably has two sliding contacts, which further preferably transmit the phase and the neutral conductor.

The brush unit 75 preferably comprises at least two brushes which are electrically connected to the sliding contacts of the slip ring unit 70. The brush unit 75 can be connected to a control unit (not shown) and to the at least one drive apparatus 80 by means of electrical lines (not shown).

The rotary bearing unit 60, moreover, comprises a base part 61, a rotating plate part 62 and a bearing 63. The bearing 63 supports the rotating plate part 62 so that it can rotate on the base part. The bearing 63 can also form the grounding or protective conductor. The rotary bearing 60 supports the rotating plate 40 by means of the bearing 63, wherein the bearing 63 can be configured as a plain bearing.

The base part 61 can be attached to the substrate 5 and can specify the positioning of the axis of rotation Z. The rotating plate part 62 is rotatably supported on the base part by means of the bearing 63, wherein a relative movement of the rotating plate part 62 along the axis of rotation Z with respect to the base part 61 is possible in order, on the one hand, to achieve compensation of tolerances and, on the other hand, to be able to compensate for any movements, such as settling behavior.

The base part 61 can, for example, be arranged directly or indirectly on a solid floor or alternatively on a concrete slab or be arranged floating in the substrate, in particular in the screed. The base part 61 can be screwed, clamped and/or bonded in place for fastening.

The rotary bearing unit 60 may, moreover, comprise a cover 64 and at least one connecting piece 65, wherein the at least one connecting piece 65 connects the cover 64, the elements 45 and the skeletal structure 46 to one another. For this purpose, the connecting piece 65 can be configured with steps.

It can, in particular, be taken from FIG. 7 that a plurality of connecting pieces 65 are arranged around the axis of rotation Z, whereby the component size of the respective connecting piece 65 can, in particular, be reduced.

As can be taken from FIG. 6 and FIG. 7, in relation to the axis of rotation Z, the rotary bearing unit 60 or alternatively the cover 64 can, moreover, have a radially aligned recess 66, which makes it possible to guide conductors and cables from the slip ring unit 70 and the brush unit 75 to the at least one drive apparatus 80. As can be taken from FIG. 6, the radially aligned recess 66 can extend over the elements 45 of the rotating plate 40. A rotary bearing can be provided so that the slip ring unit and brush unit can rotate in alignment with one another.

FIG. 8 through FIG. 11 show different views of one of the support units 20.

According to FIG. 1, the support units 20 are arranged in a distributed manner about the circumference within the circular area around the axis of rotation Z. In total, multiple groups of support units 20 can be arranged at different radii in a circle around the axis of rotation Z. The respective group may comprise a plurality of support units 20, wherein the number of the support units 20 in the groups may be different. The support units 20 of the respective group are preferably arranged symmetrically about the circumference.

In the embodiment example shown in FIG. 1, a first group comprises five support units 20, a second group comprises eleven support units 20, and the radially outer third group comprises 15 support units 20.

With reference to the accompanying FIG. 8 through FIG. 11, it can be seen that the respective support unit 20 comprises a housing 25 and a roller bearing element 30. The respective support unit 20 is an individual component that can be inserted into a recess 6 (see FIG. 15) of the substrate 5. The respective support units 20 are therefore not directly connected to the other components of the rotating device 1, but only indirectly via the substrate.

The respective support unit 20 is arranged along a vertical axis Z1, wherein the vertical axis Z1 is preferably oriented parallel to and at a distance from the axis of rotation Z.

As shown, the housing 25 can be sleeve-shaped, wherein the axis of symmetry or center axis of the housing 25 corresponds to the vertical axis Z1.

The housing 25, moreover, comprises a supporting surface 28, which, in relation to the vertical axis, projects radially from the housing 25 in a flange-like manner at the end. The supporting surfaces 28 are provided to come into contact with the substrate 5 and to transfer the loads of the respective support unit 20 to the substrate 5.

The roller bearing element 30 is mounted on the housing 25 and can support the rotating plate 40 so that it can rotate relative to the housing 25.

The roller bearing element 30 comprises a rolling element 31 configured as a roller, which can, for example, have a rolling element surface made of metal, rubber or plastic, by means of which the rolling element 31 can roll particularly silently on the rotating plate 40.

The respective support unit 20 can, moreover, comprise an adjusting means 32, by means of which the roller bearing element 30 is movable in the vertical axis Z1 relative to the housing 25. The adjusting means 32 makes it possible to compensate for any unevenness in the substrate.

In the illustrated embodiment example, the adjusting means 32 comprises a screw sleeve 34, which can be screwed into the housing 25. The roller bearing element 30 is rotatably supported in the screw sleeve 34 and by a rotation of the screw sleeve 34 in the housing 25 about the vertical axis Z1, the roller bearing element 30 can be moved along the vertical axis Z1 relative to the housing 25.

It can, moreover, be taken from FIG. 8 through FIG. 11 that a fixing means 33 is provided, by means of which the adjusting means 32 can be blocked. The fixing means 33 can comprise a catch which, for example, projects from the screw sleeve 34 into an axial groove on an inner lateral surface of the housing 25. The fixing means 33 can also comprise a clamping screw, a bolt or a mechanical lock as chosen by the person skilled in the art.

As can be seen in FIG. 8 and FIG. 10, the roller bearing element 30 protrudes from the housing 25 in the vertical axis Z1 and can roll on a bearing surface 44 on the bearing side 42 of the rotating plate 40 as shown in FIG. 8.

The respective bearing surface 44 on the bearing side 42 of the rotating plate 40 is ring-shaped and is arranged concentrically to the axis of rotation Z. The position of the respective bearing surface 44 corresponds to the respective grouped arrangement of the support units 20.

As is particularly apparent from FIG. 1, the annular bearing surfaces 44 are formed by the skeletal structure 46 of the rotating plate 40, wherein the skeletal structure 46 and the frames 47, 48 respectively comprise corresponding arcuate portions forming the bearing surface 44.

The frames 47, 48 can have an arrow-shaped geometry at the butt joints between two adjacent frames 47, 48. These angled transitions at the butt joints in the area of the respective bearing surface 44 allow the preferably large support rollers 30 to roll smoothly over the bearing surface 44. This contributes in particular to the smooth running of the rotating plate 40.

The drive apparatus 80 is illustrated in detail in FIG. 12 through FIG. 14, wherein different views of the drive apparatus 80, which is configured as an assembly, are shown.

The drive apparatus 80 comprises a rack 82. The drive apparatus 80 can be detachably mounted as an assembly on the room side 41 of the rotating plate 40 by means of the rack 82 and preferably comprises a drive 90 and a friction wheel 84.

The drive apparatus 80 can, moreover, comprise a decoupling device 86, which preferably decouples the friction wheel 84 and/or the drive 90 from the rotating plate 40 or alternatively the rack 82 in terms of vibration mechanics. This suppresses the transmission of running noises from the friction wheel 84 to the rotating plate 40. A corresponding configuration of the decoupling device 86 can, moreover, generate a contact pressure that presses the friction wheel 84 against the substrate 5.

The decoupling device 86 can, for example, comprise an arm 88 that can pivot about a pivot axis X. The drive 90 and also the friction wheel 84 driven by the drive 90 can be arranged on this arm 88. A spring and/or damper unit 92 can, moreover, damp and/or resiliently support the arm 88 relative to the rack, so that the friction wheel 84 can perform a sprung and/or damped pivoting movement, which is indicated by a double arrow in FIG. 12.

The friction wheel 84 passes through the rotating plate 40 or alternatively the respective element 45 of the rotating plate 40 in a recess 48 and can roll on the substrate 5. To reduce running noise, the friction wheel 84 can be configured as a tire and/or have a running surface made of rubber, plastic or the like.

As can also be taken from FIG. 1 and FIG. 3, the rotating device 1 can also comprise one or even a plurality of drive apparatuses 80.

The fact that a control unit can be provided is not shown in the figures. The control unit is preferably arranged on the rotating plate 40 and can, for example, receive control commands from a remote control or a higher-level system. The control unit can convert the control commands into a movement of the rotating plate 40 by means of the drive apparatuses 80.

FIG. 15 shows a cross-section through a rotating plate arrangement with the previously described rotating device 1 and the substrate 5, wherein it can be seen that the support units 20 are each inserted individually into a recess 6 in the substrate 5. The support units 20 can either be inserted loosely into the respective recess 6 or fastened in the recess 6 by fastening means (not shown). By way of example, the support units 20 can be bonded and/or clamped into the respective recess 6.

The rotary bearing unit 60 is inserted into a recess 7 and can also be attached there.

The substrate 5 is a floating screed floor that can be laid on a heat insulation layer 12. A separating layer 11 can be provided between the heat insulation layer 12 and the screed. The reference sign 10 indicates a solid floor, for example, a concrete slab.

The rotating device 1 has a room-dividing element 58 on the room side 41 of the rotating plate 40. An electrical outlet can, moreover, be provided, which outlet is arranged on the room-dividing element 58 in the illustrated embodiment example. The electrical outlet 57 is supplied with mains power by means of the slip ring unit 70 and the brush unit 75.

A piece of furnishing 56 which is positioned in such a way that the at least one drive apparatus 80 is arranged concealed in the space, can, moreover, be seen in FIG. 15.

FIG. 16 shows a further development of the rotating plate arrangement with a plurality of rotating devices 1 described above and a plurality of, preferably driverless, vehicles 100 that can drive over the substrate 5. The vehicles 100 can drive on to and off the respective rotating device 1. A control system, not shown, controls both the driverless vehicles 100 and the respective rotating device 1, whereby a coordinated or synchronized movement can be generated.

### LIST OF REFERENCE SIGNS

1 Rotating device
5 Substrate
6 Recess
7 Recess
10 Solid floor
11 Separating layer
12 Heat insulation layer
20 Support unit
25 Housing
28 Supporting surface
30 Roller bearing element
31 Rolling element
32 Adjusting means
33 Fixing means
34 Screw sleeve
40 Rotating plate
41 Room side
42 Bearing side
43 Recess
44 Bearing surface
45 Element
46 Skeletal structure
47 Frame
48 Frame
49 Positive-locking element
56 Piece of furnishing
57 Electrical outlet
58 Room-dividing element
60 Rotary bearing unit
61 Base part
62 Rotating plate part
63 Bearing
64 Cover
65 Connecting piece
66 Recess
70 Slip ring unit
75 Brush unit
80 Drive apparatus
82 Rack
84 Friction wheel
86 Decoupling device
88 Arm
90 Drive
92 Damper unit
100 Vehicle
X Pivot axis
Z Axis of rotation
Z1 Vertical axis

1. Rotating device (1) for integration in a substrate (5), preferably in a building floor element, more particularly in a screed floor, having
at least three support units (20), which can be arranged individually in the circumference of the substrate (5) within a circular area about an axis of rotation (Z),
a rotating plate (40) which extends at least over the circular area and has a room side (41) and a bearing side (42) opposite the room side (41),
a rotary bearing unit (60), and
at least one drive apparatus (80),
wherein the rotating plate (40) is rotatably mounted in the axis of rotation (Z) and the at least three support units (20) support the rotating plate (40) in a rotationally movable manner in the orientation of the axis of rotation (X) in a vertical axis (Z1) on the bearing side (42), and
wherein the drive apparatus (80) is configured to set the rotating plate (40) in rotation about the axis of rotation (Z).

2. Rotating device (1) according to claim 1,
characterized in that
the at least one drive apparatus (80) is arranged on the rotating plate (40).

3. Rotating device (1) according to claim 1,
characterized in that
the at least one drive apparatus (80) comprises a friction wheel (84).

4. Rotating device (1) according to claim 1,
characterized in that
the at least one drive apparatus (80) is arranged substantially on the room side (41) of the rotating plate (40).

5. Rotating device (1) according to claim 1,
characterized in that
the friction wheel (84) passes through the rotating plate (40) through a recess (48).

6. Rotating device (1) according to claim 1,
characterized in that
a slip ring unit (70) and a brush unit (75) interacting with the slip ring unit (70) are provided, by means of which the rotating plate (40) can be supplied with electric current.

7. Rotating device (1) according to claim 1,
characterized in that
the rotary bearing unit (60) comprises the slip ring unit (70).

8. Rotating device (1) according to claim 1,
characterized in that
the rotary bearing unit (60) comprises a base part (61) and a rotating plate part (62), wherein the rotating plate part (62) is movable along the axis of rotation (Z) relative to the base part (61).

9. Rotating device (1) according to claim 1,
characterized in that
a, preferably remotely controllable, control unit is provided for controlling the drive apparatus (80).

10. Rotating device (1) according to claim 1,
characterized in that
the control unit (75) is arranged on the rotating plate (40).

11. Rotating device (1) according to claim 1,
characterized in that
the drive apparatus (80) comprises an electric drive for generating the rotation of the rotating plate (40) about the axis of rotation (Z).

12. Rotating device (1) according to claim 1,
characterized in that
the at least one of the at least three support units (20) comprises a housing (25) and a roller bearing element (30) supported on the housing (25).

13. Rotating device (1) according to claim 1,
characterized in that
the at least one of the at least three support units (20) comprises a housing (25) and an air bearing means.

14. Rotating device (1) according to claim 1,
characterized in that
a supporting surface (28) projecting from the housing (25) is provided.

15. Rotating device (1) according to claim 1,
characterized in that
the roller bearing element (30) is movable in the vertical axis (Z1) by an adjusting means (32).

16. Rotating device (1) according to claim 1,
characterized in that
the adjusting means (32) comprises a screw sleeve (34) which can be screwed into the housing (25).

17. Rotating device (1) according to claim 1,
characterized in that
a fixing means (33) is provided, which can fix the adjusting means (32) relative to the housing (25).

18. Rotating device (1) according to claim 1,
characterized in that
the rotating plate (40) has at least one annular bearing surface (44) on the bearing side (42) around the axis of rotation.

19. Rotating device (1) according to claim 1,
characterized in that
the rotating plate (40), that is preferably adjacent to the at least one annular bearing surface (44), has at least one aperture through which at least one of the at least three support units (20) is accessible.

20. Rotating device (1) according to claim 1,
characterized in that
the rotating plate (40) is made up of a plurality of, preferably circular sector-shaped, elements (45).

21. Rotating device (1) according to claim 1,
characterized in that
the rotating plate (40) is circular and has a diameter of more than 4 meters.

22. Rotating device (1) according to claim 1,
characterized in that
the at least three support units (20) have a length (L) in the vertical axis (Z1) of less than 50 mm, preferably less than 45 mm.

23. Rotating device (1) according to claim 1,
characterized in that
a room-dividing element (58), in particular a room partition wall, is arranged on the room side (41) of the rotating plate (40).

24. Rotating device (1) according to claim 1,
characterized in that
the room-dividing element (58) comprises an electrical outlet (59).

25. Rotating plate arrangement with at least one rotating device (1) according to claim 1, and a substrate (5), preferably a building floor element, more particularly in a screed floor, wherein the at least three support units (20) and the rotary bearing unit (60) are respectively arranged in one of recesses (6, 7) in the substrate (5).

26. Rotating plate arrangement according to claim 24,
characterized in that
at least one, preferably driverless, vehicle (100) is provided and that a control system controls the at least one vehicle (100) and at least one rotating device (1).
